(19) United States
(12) Patent Application Publication
(10) Pub. No.: US 2014/0139344 A1
(43) Pub. Date: May 22, 2014

(54) WARNING LIGHT DEVICES AND METHODS

(71) Applicant: SNAP-ON INCORPORATED, Kenosha, WI (US)

(72) Inventor: Frederick C. Chudy, Greenfield, WI (US)

(73) Assignee: Snap-on Incorporated, Kenosha, WI (US)

(21) Appl. No.: 13/680,776

(22) Filed: Nov. 19, 2012

(51) Int. Cl. G08B 21/18

(52) U.S. Cl. CPC G08B 21/182
USPC 340/636.15

(57) ABSTRACT

An electronic device or tool including an indicator adapted to provide an indication when a predetermined amount of time of operation of the electronic device, for example about 10 minutes, remains in the power source. The indicator device indicates to a user that the user has a certain amount of time of operation of the electronic device before the electronic device will shut down and become inoperable.

### TECHNICAL FIELD OF THE INVENTION

The present application relates to methods for battery operated electrical devices. In particular, the present application relates to warning light indicators for battery operated electrical devices.

### BACKGROUND OF THE INVENTION

There are numerous electronic devices that utilize a battery as a power source, including constant load current electronic devices and variable load current electronic devices. In general, these battery powered electronic devices turn off suddenly when the battery voltage is reduced to a certain low voltage level. The shutdown of the device can happen in the midst of a user operating the electronic device without warning, thereby causing the user to discontinue operation of the electronic device and change or recharge the battery of the electronic device.

### SUMMARY OF THEN INVENTION

The present application discloses devices and methods for providing a warning light on an electronic device having a power source to illustrate to the user the amount of life remaining in the power source. In an illustrative embodiment, the warning light blinks or flashes when a predetermined amount of time of operation for operating the electronic device, for example, about 10 to 15 minutes, remains in a battery power source. The warning light thereby notifies the user of the remaining amount of time before the battery can no longer power the device.

In an embodiment, a warning light device for a power tool, such as a power drill, includes a power source adapted to supply power to the tool and having a voltage level, a control circuit electrically coupled to the power source and adapted to monitor the voltage level of the power source, and a light electrically coupled to the control circuit and adapted to be activated when the control circuit determines the voltage level is at or below a predetermined amount corresponding to a predetermined time quantity in which the power source can continue to supply power the tool.

In another embodiment, the warning light device includes a power source adapted to supply power to the tool, a control circuit electrically coupled to the power source, wherein the control circuit is adapted to monitor a rate of voltage discharge of the power source and calculate a remaining time that the power source can continue to supply power to the tool based on past usage of the power source, and a light electrically coupled to the control circuit and adapted to be activated when the control circuit determines the remaining time quantity reaches a predetermined time quantity.

In yet another embodiment, the warning light device includes a power source adapted to supply power to the tool, a control circuit electrically coupled to the power source, wherein the control circuit is adapted to identify a power consumption setting of the power source and determine a remaining time quantity in which the power source can supply power to the tool based on the power consumption setting, and a light electrically coupled to the control circuit and adapted to be activated when the control circuit determines the remaining time quantity reaches a predetermined time quantity.

### BRIEF DESCRIPTION OF THE DRAWINGS

Embodiments of devices and methods are illustrated in the figures of the accompanying drawings which are meant to be exemplary and not limiting, in which like references are intended to refer to like or corresponding parts, and in which:

FIG. 1 is a functional block diagram of an embodiment of an indicator of the present application.

FIG. 2 is a block flow diagram of a method of operation of an embodiment of the indicator of the present application.

FIG. 3 is a block flow diagram of a method of operation of another embodiment of the indicator of the present application.

FIG. 4 is a perspective view of an embodiment of an electronic device including an indicator of the present application.

### DETAILED DESCRIPTION OF THE EMBODIMENTS

Detailed embodiments of devices and methods are disclosed herein. However, it is to be understood that the disclosed embodiments are merely exemplary of the devices and methods, which may be embodied in various forms. Therefore, specific functional details disclosed herein are not to be interpreted as limiting, but merely as a basis for the claims and as a representative basis for teaching one skilled in the art to variously employ the present disclosure.

The present application relates to an indicator, such as a warning light, on an electronic device having a power source. The indicator is adapted to activate and, for example, blink, flash or provide other types of visual, auditory or tactile feedback, when the power source reaches a predetermined amount of time remaining to supply power to the electronic device.

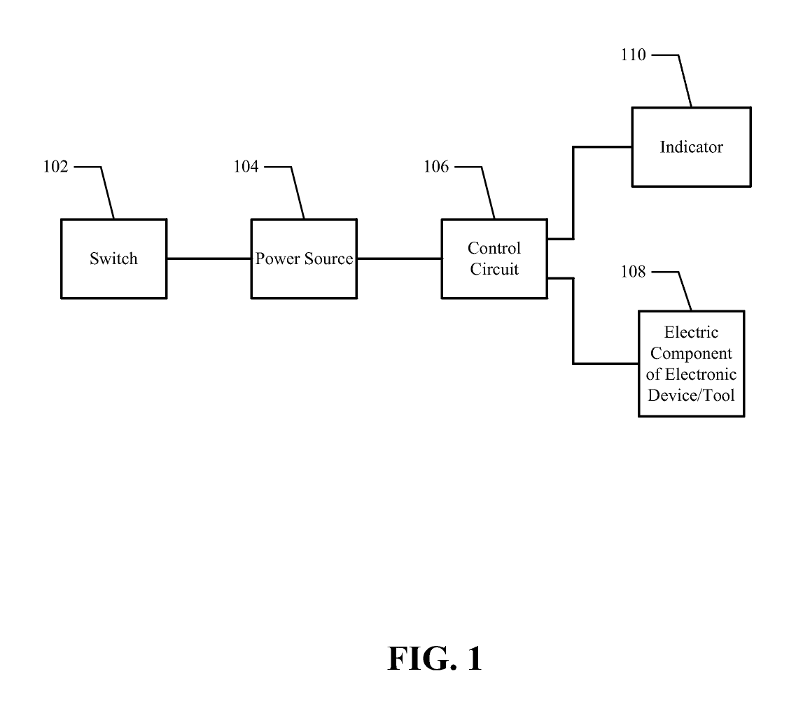

FIG. 1 illustrates a functional block diagram of an indicator implemented in an electronic device. As shown, the indicator device includes a switch 102, a power source 104, a control circuit 106, an electronic component 108 of an electronic device, and an indicator 110.

The switch 102 is electrically coupled to the power source 104, and may be, for example, a power on/off switch or a trigger. Activation of or placement of the switch 102 in an ON position causes the power source 104 to supply power or voltage to the electric component 108 for operating the electronic device.

The power source 104 is electrically coupled to the switch 102, the control circuit 106, and the electric component 108, and supplies electrical power to the electric component 108 directly or through the control circuit 106. The power source 104 may be any appropriate voltage or current source, such as a battery, a magneto, a fuel cell, a solar cell, and the like, providing any appropriate current and/or voltage, such as about 6 Volts, about 7.2 Volts, about 12 Volts, about 42 Volts and the like. In an embodiment, the power source 104 may be any type of battery or rechargeable battery capable of supplying enough voltage to the electric component(s) 108 to operate the electronic device. For example, the power source 104 may be a lithium-ion (Li-ion) battery, a nickel cadmium (NiCd) battery, a nickel metal hydride (NiMH) battery, a lithium ion polymer (Li-ion polymer) battery, or any other form of electrical or mechanical power source, or combinations thereof.

The control circuit 106 is adapted to prevent the passage of electrical current to the indicator 110 and allow the passage of electrical current to the indicator 110 when the power source 104 has a predetermined amount of time of operation remaining for the power source 104. The control circuit 106 may include one or more circuits and/or circuit components adapted to receive voltage from the power source 104 and allow voltage to pass to the indicator 110 when the predetermined amount of time of operation remains. For example, the control circuit 106 may include one or more circuit components, for example, integrated circuits, resistors, capacitors, amplifiers, gates, switch circuits, and other circuit components. The control circuit 106 can also include a processor to effect the necessary operations of the described system and/or the electronic device/tool, or a memory to store data related to the operation of the electronic device/tool or any other data, such as historical usage.

The control circuit 106 may also be adapted to monitor the voltage level of the power source 104 continuously or periodically and calculate or determine an amount of time of operation remaining for operating the electronic device based on the remaining voltage level of the power source 104. In an illustrative embodiment, the control circuit 106 may activate the indicator 110 when the amount of time of operation remaining is, for example, about 15 minutes.

To determine when the indicator 110 is activated, the control circuit 106 can monitor historical usage of the electronic device and calculate an estimated amount of time remaining before the power source 104 becomes “dead,” i.e., can no longer supply power to the electronic device. Alternatively, the control circuit 106 can determine a current power consumption setting of the electronic device (e.g., a low power consumption, medium power consumption, or high power consumption setting) and calculate an amount of time remaining based on that current setting. Any other method of calculating the remaining battery life can be implemented without departing from the spirit and scope of the present application.

The electric component 108 may be any electric component capable of receiving voltage supplied by the power source 104 and causing the electronic device to operate according to its intended function. For example, the electric component 108 may be a motor, a light source, a heat source, a hydraulic, a pump, an audio speaker, or any other electrical or mechanical component. In one example, the electronic device is a drill and the electric component 108 is a motor that rotates a working end or bit of the drill. In another example, the electronic device is a work light or flashlight and the electric component 108 is a light source, such as a light bulb, that illuminates.

The indicator 110 is electrically coupled to the control circuit 106. The indicator 110 can be any component capable of providing feedback, for example, a speaker that provides an auditory tone, a LCD display to provide a visual indication or a tactile feedback device to provide tactile feedback. For example, the indicator can include a blinking light that provides a signal to the user that the power source 104 has 15 minutes remaining before it can no longer sufficiently supply power to the electronic device. The indicator therefore serves as a warning to the user that a predetermined amount of battery life, measured in time, remains before the battery can no longer power the electronic device. In an illustrative embodiment, the indicator 110 is an LED capable of flashing or blinking.

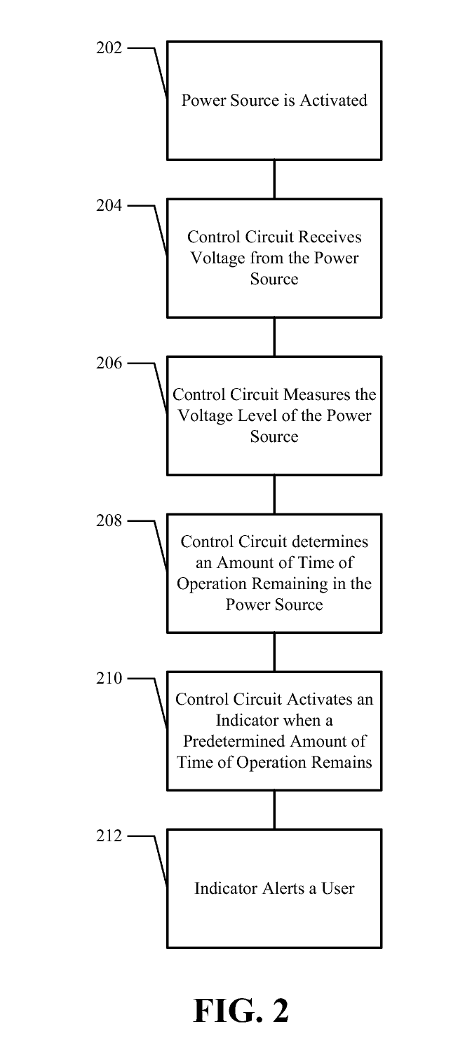

FIG. 2 illustrates a method of operating the indicator device according to an embodiment of the present application. A power source, for example, a battery, is activated 202, and voltage is supplied to one or more electric components of the electronic device. A control circuit receives voltage from the power source 204 and measures the remaining voltage level of the power source 206. The control circuit calculates an amount of time of operation remaining in the power source for operating the electronic device, for example, based on the remaining voltage level 208. The control circuit then activates an indicator, for example, a flashing LED, when a predetermined amount of time of operation, for example, about 10 minutes remains 210. The indicator flashes to alert the user that the power source has, for example, about 10 minutes of time remaining for operating the electronic device 212.

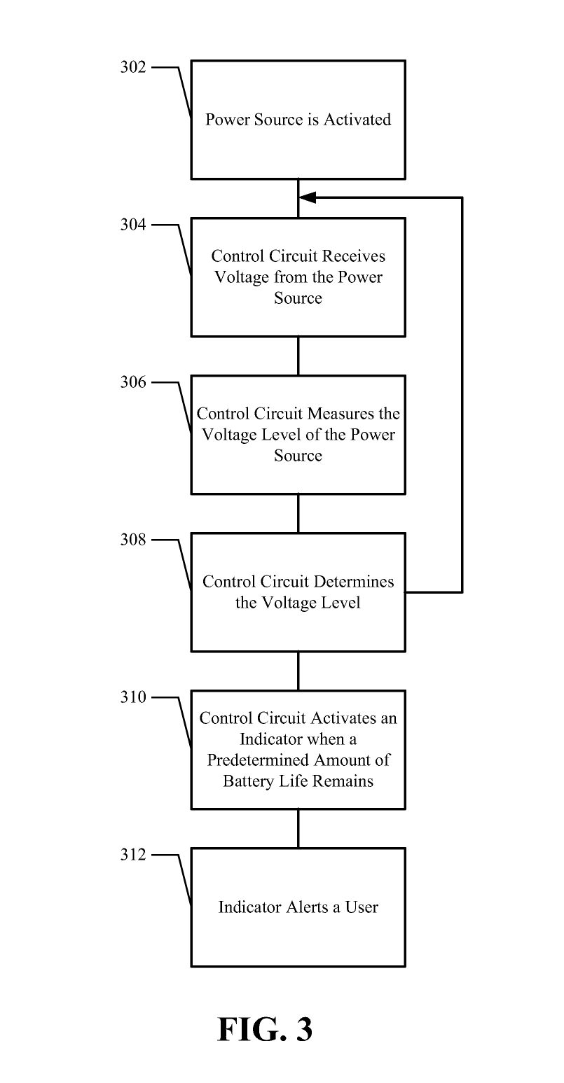

FIG. 3 illustrates a method of operating the indicator device according to an embodiment of the present application. Similar to the method described above, the method of FIG. 3 begins by activating the power source 302. The control circuit receives voltage from the power source 304 and measures the voltage level of the power source while the electronic device is operated 306, thereby determining the voltage level 308. The process of steps 304-308 may be repeated until the control circuit determines that a predetermined amount of battery life remains 310 and the indicator provides an alert or indication to the user that the power source has a certain amount of time before being inoperable to power the device 312.

The above process determines the amount of battery life remaining based on a current rate of usage or rate of discharge of the battery. For example, if a user aggressively operates the electronic device such that the battery life is quickly drained, the embodiment of FIG. 3 can determine how much battery life remains assuming or predicting the future rate of discharge will be the same as a historical rate of discharge. Alternately, the above embodiment of FIG. 3 can calculate a power consumption setting of the electronic device (e.g., a low power consumption, medium power consumption, or high power consumption setting) and calculate an amount of time remaining based on that current setting. The embodiment of FIG. 2, however, determines the battery life remaining based on the remaining voltage level of the power source.

By taking into account the usage of the electronic device and the setting(s) of the electronic device, the control circuit 106 can more accurately activate the indicator 110 when a predetermined amount of time of operation remaining is reached. For example, if the electronic device is a drill, a low torque setting may use less voltage than a high torque setting. Similarly, if the electronic device is a flashlight having multiple brightness levels, the power source 104 would drain more quickly at the higher brightness level compared to the lower brightness level. The embodiment of FIG. 3, therefore, analyzes usage of the tool and does not simply calculate the time remaining for the battery based on the measured voltage level of the battery.

Although the amount of time of operation remaining is described as being based on a voltage level of the power source, a current rate of usage, or a power consumption setting, the amount of time of operation remaining may be determined based on a combination of one or more of the voltage level, the current rate of usage, and the power consumption setting. In this embodiment, the control circuit 106 may combine one or more of the various parameters and determine an average amount of time of operation remaining and activate the indicator 110 based on this average amount of time of operation remaining.

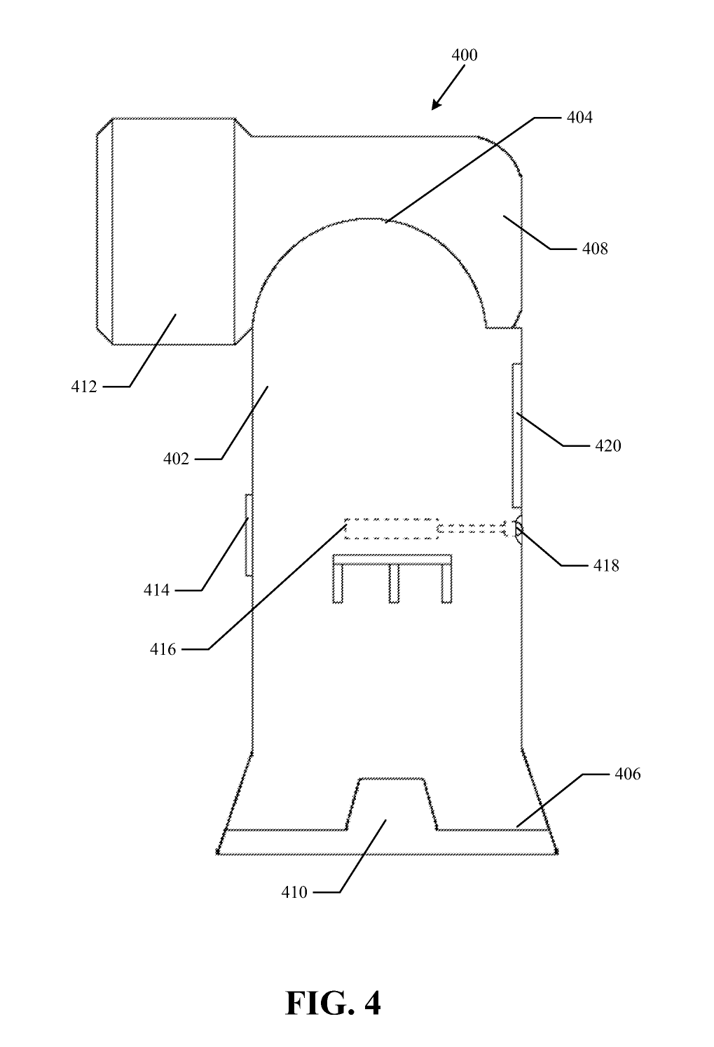

An example of an electronic device, a work light 400, including the indicator device according to an illustrative embodiment is described with reference to FIG. 4. The work light 400 includes a housing 402 having a first end 404 and a second end 406, a head portion 408 or working portion coupled to the first end 404, a power source 410 adapted to be received in the housing 402 and couple to the second end 406, a switch 414, a control circuit 416 and a flashing LED 418 disposed in the housing 402.

The head portion 408 is adapted to pivot or rotate about 120 degrees from vertical alignment with the housing 402. The head portion 408 may include a light source receiving portion 412, and a light source, for example, one or more bulbs or LEDs, (not shown) disposed in the light source receiving portion 412 and adapted to electrically couple to the power source 410 when the power source 410 is disposed in the housing 402.

The switch 414 is adapted to operably couple to the power source 410 when the power source 410 is disposed in the housing 402 to activate and deactivate voltage flow from the power source 410 to the light source when in an ON position and an OFF position, respectively.

The control circuit 416 is adapted to electrically couple to the power source 410 when the power source 410 is disposed in the housing 402. The control circuit 416 is electrically coupled to the flashing LED 418, and is adapted to activate and deactivate voltage flow to the flashing LED 418. In this embodiment, the flashing LED 418 extends through an exterior of the housing 402 allowing the flashing LED 418 to be visible to a user.

The work light 400 may activate the flashing LED 418 indicating that a predetermined amount of time of operation of the work light 400 remains in the power source 410. In this embodiment, the flashing LED 418 is activated when the Li-ion battery 410 has about 10 minutes of operation time remaining. As discussed above, this remaining 10 minutes can be calculated by either the voltage level of the battery, the expected rate of usage of the battery based on historical usage, or the current power consumption setting of the work light 400.

Although the devices and methods are described above as implemented in a work light, it should be appreciated by those skilled in the art that the devices and methods disclosed herein include and may be implemented within a number of different battery or otherwise operated electronic or mechanical devices, including constant load current electronic devices, for example, including but not limited to, flashlights and other lights, radios, vacuums, glue guns, cameras, detention tools, and other tools and electronic devices of the type; and variable load current electronic devices, for example, including but not limited to, variable speed/torque drills, screwdrivers, impact wrenches, razors, caulk/adhesive guns, and other rotary and non-rotary tools and electronic devices of the type. Further, the working portion of the tool may be a rotating head, for example, as included in a drill, screwdriver, and a wrench; a suction hose, for example, as included in a vacuum; a speaker, for example, as included in a radio; etc.

Although the devices and methods have been described and illustrated in connection with certain embodiments, many variations and modifications will be evident to those skilled in the art and may be made without departing from the spirit and scope of the present disclosure. The present disclosure is thus not to be limited to the precise details of methodology or construction set forth above as such variations and modification are intended to be included within the scope of the present disclosure.

What is claimed is:

1. An indicator device for a tool comprising:
a power source adapted to supply power to the tool and having a voltage level;
a control circuit electrically coupled to the power source and adapted to monitor the power level of the power source; and
an indicator electrically coupled to the control circuit and adapted to be activated when the control circuit determines the voltage level is at or below a predetermined amount corresponding to a predetermined amount of time in which the power source can supply power to the tool.

2. The indicator device of claim 1, wherein the indicator is a light that is adapted to flash when activated.

3. The indicator device of claim 2, wherein the light is a light-emitting diode.

4. The indicator device of claim 1, wherein the power source is a Lithium-ion battery.

5. The indicator device of claim 1, wherein the indicator is adapted to provide a feedback selected from the group consisting of a visual feedback, an auditory feedback, and a tactile feedback when activated.

6. A indicator device for a tool comprising:
a power source adapted to supply power to the tool;
a control circuit electrically coupled to the power source, the control circuit adapted to monitor a historical usage of the power source and determine an amount of remaining time in which the power source can supply power to the tool based on the historical usage; and
an indicator electrically coupled to the control circuit and adapted to be activated when the control circuit determines the amount of remaining time reaches a predetermined time quantity.

7. The indicator device of claim 6, wherein the historical usage is based on a rate of discharge of the power source.

8. The indicator device of claim 7, wherein the amount of remaining time is determined by predicting a future rate of power discharge of the power source.

9. The indicator device of claim 6, wherein the control circuit includes a memory adapted to store the historical usage.

10. The indicator device of claim 6, wherein the indicator is adapted to provide a feedback selected from the group consisting of a visual feedback, an auditory feedback, and a tactile feedback when activated.

11. The indicator device of claim 6, wherein the indicator is a light adapted to flash when activated.

12. The warning light device of claim 11, wherein the light is a light-emitting diode.

13. An indicator device for a tool comprising:
a power source adapted to supply power to the tool;
a control circuit electrically coupled to the power source, the control circuit adapted to identify a power consumption setting of the power source and determine an amount of remaining time in which the power source can supply power to the tool based on the power consumption setting; and
an indicator electrically coupled to the control circuit and adapted to be activated when the control circuit determines the remaining time quantity reaches a predetermined time quantity.

14. The indicator device of claim 13, wherein the power consumption setting is one of a low power consumption setting, a medium power consumption setting, and a high power consumption setting.

15. The indicator device of claim 13, wherein the indicator is adapted to provide a feedback selected from the group consisting of a visual feedback, an auditory feedback, and a tactile feedback when activated.

16. The indicator device of claim 13, wherein the indicator is a light adapted to flash when activated.

17. The indicator device of claim 13, wherein the control circuit is further adapted to monitor a historical usage of the power source and determine the amount of remaining time in which the power source can supply power the tool based on a combination of the power consumption setting and the historical usage.
